(19) United States
(12) Patent Application Publication
(10) Pub. No.: US 2008/0301735 A1
(43) Pub. Date: Dec. 4, 2008

(54) USER INTERFACE SCREEN MAGNIFYING GLASS EFFECT

(76) Inventor: Christian Thomas Chicles, Orlando, FL (US)

Correspondence Address: Wm. Brook Lafferty;Scientific-Atlanta, Inc., Intellectual Property Dept. MS 4.3.518, 5030 Sugarloaf Parkway, Lawrenceville, GA, 30044, US

(21) Appl. No.: 11/755,885

(22) Filed: May 31, 2007

(51) Int. Cl. H04N 5/445

(52) U.S. Cl. 725/47

(57) ABSTRACT

An electronic program guide (EPG) having a magnifying glass effect to enlarge the font size of a portion of the television program data presented in a grid format. The magnifying glass effect options are selected by the user. The magnifying glass effect can be stationary on the screen and have text scroll underneath it or it can be used in conjunction with the highlighting effect so that every highlighted item is magnified. The magnifying glass effect could always be in use, activated by the amount of time a field is highlighted, or activated by user input.

### TECHNICAL FIELD

The present invention relates to rendering of user interface screens and, more particularly, relates to providing an electronic program guide for use in a subscription television system where a user is permitted to select programs from the electronic program guide.

### BACKGROUND OF THE INVENTION

Subscription television systems typically include an electronic program guide (EPG). With the development of interactive digital set-top terminals (STTs), a new type of advanced multimedia EPGs were developed which may be referred to sometimes as interactive program guides (IPGs). Today, the acronyms EPG and IPG may be used interchangeably.

The IPG provides an onscreen display of a program grid menu that includes a program lineup and episode information for every channel for the next several days. The program grid menu may be arranged in various ways. The program grid menu itself is a user interface where the user may navigate the program grid menu using arrow keys on a remote. For example, FIG. 1 illustrates a typical IPG having a program grid menu based on available channel and time. The user can navigate or scroll through the list of programs within the selected time slot until the desired program is highlighted. Typically, a field in the IPG is shown as being highlighted by using a different color background relative the backgrounds of any other field. In such case, the selectable field may be referred to as a pill.

Once the desired field is highlighted as a selectable item, the user may select the highlighted field using the select button on the remote. In FIG. 1, the user has highlighted the field corresponding with the program titled “Football” which, in turn, corresponds with SPORTS1 channel 1937. The surrounding boundary or edge of the field corresponding with “Football” has been bolded to depict being highlighted. The boundaries of other fields associated with the highlighted field may also be bolded such as the corresponding channel and time.

FIG. 2 also illustrates a menu of options in which the user may interface. The user may scroll through a list of preferences until the desired field is highlighted. The highlighted field becomes selectable and therefore may be referred to as active. The user may then select that option to change its current status. Bolding is used again in FIG. 2 to depict the Pay-Per-View (PPV) Purchases option being highlighted. Although FIGS. 1 and 2 illustrate two particular examples where a field is highlighted within the IPG, today's IPGs include hundreds or even thousands of possibilities which the user may scroll through, highlight and select.

However, because of the large amount of data displayed on an IPG, the font size of the text is small and many users have trouble reading the small text. There is a need to allow users to enlarge specific text as they scroll through an IPG.

### BRIEF DESCRIPTION OF THE DRAWINGS

FIG. 1 illustrates a screen-shot of a prior art graphical user interface screen depicting a selectable item.

FIG. 2 illustrates a screen-shot of another prior art graphical user interface screen depicting a selectable item.

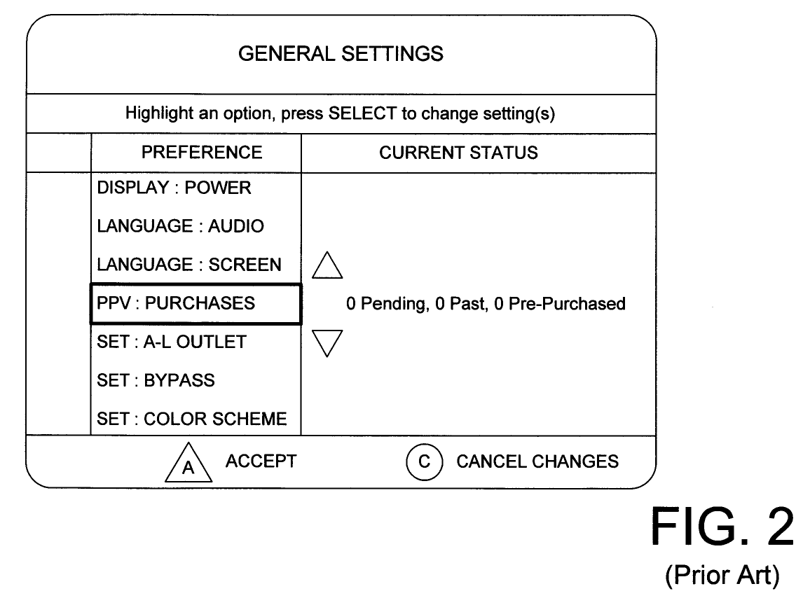

FIG. 3 illustrates a screen-shot of a graphical user interface screen having a magnifying glass effect according to one embodiment of the present invention.

FIG. 4 illustrates a screen-shot of a graphical user interface screen having a button-activated magnifying glass effect according to one embodiment of the present invention.

FIG. 5 illustrates a screen-shot of a graphical user interface screen having a magnifying glass effect according to an embodiment of the present invention.

FIG. 6 illustrates a screen-shot of a graphical user interface screen having two instances of the magnifying glass effect according to an embodiment of the present invention.

### DETAILED DESCRIPTION

The present invention will be described more fully hereinafter with reference to the accompanying drawings in which like numerals represent like elements throughout the several figures, and in which an exemplary embodiment of the invention is shown. This invention may, however, be embodied in many different forms and should not be construed as being limited to the embodiments set forth herein; rather, the embodiments are provided so that this disclosure will be thorough and complete, and will fully convey the scope of the invention to those skilled in the art. The present invention is described more fully hereinbelow.

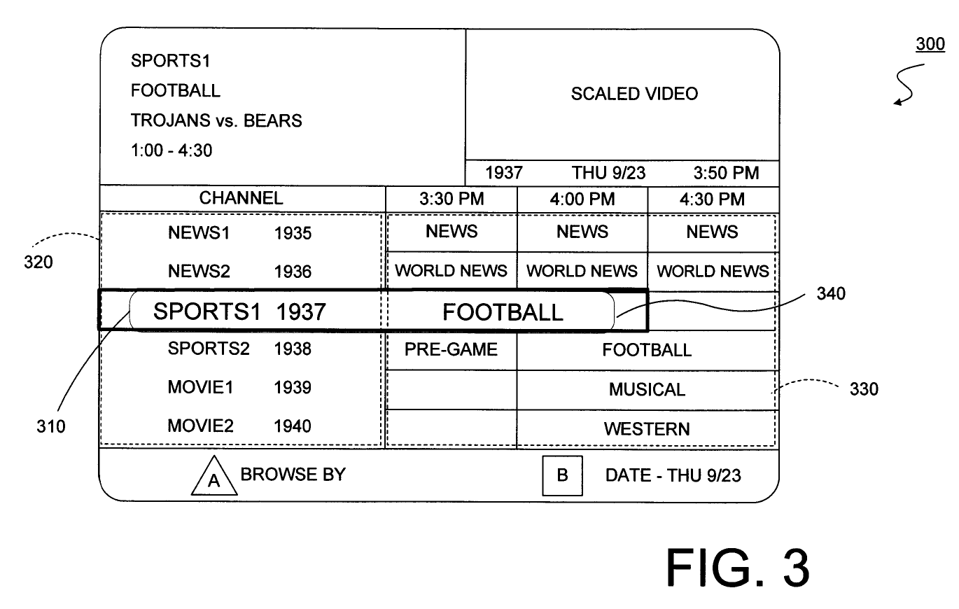

FIG. 3 illustrates a screen-shot of a graphical user interface screen 300 having magnifying glass effect 310 according to one embodiment of the present invention. The magnifying glass effect 310 is preferably utilized as part of interactive television such as with an EPG/IPG as shown in FIG. 3. However, the magnifying glass effect 310 may be utilized elsewhere as part of any graphical user interface that may be implemented as part of, for example, video games, interactive course ware, PDA's, cell phones, etc.

The user interface screen 300 of FIG. 3 includes a grid menu of television programs identified by time and channel. As explained above, the television programs may be arranged in any other manner. Preferably, the user interface screen 300 is created by utilizing images which may be tiled or stretched as background for displayed text. These background images may be tiled in either horizontal or vertical directions. Those skilled in the art appreciate that any tilable image carries with it information so that the image can morph itself when the image is displayed. For example, in FIG. 3, the user interface screen 300 includes a background image 320 which corresponds with the list of channels and another background image 330 which corresponds with the program grid of television programs. Images 320 and 330 are depicted by broken lines. Other background images may be utilized elsewhere in the user interface screen 300.

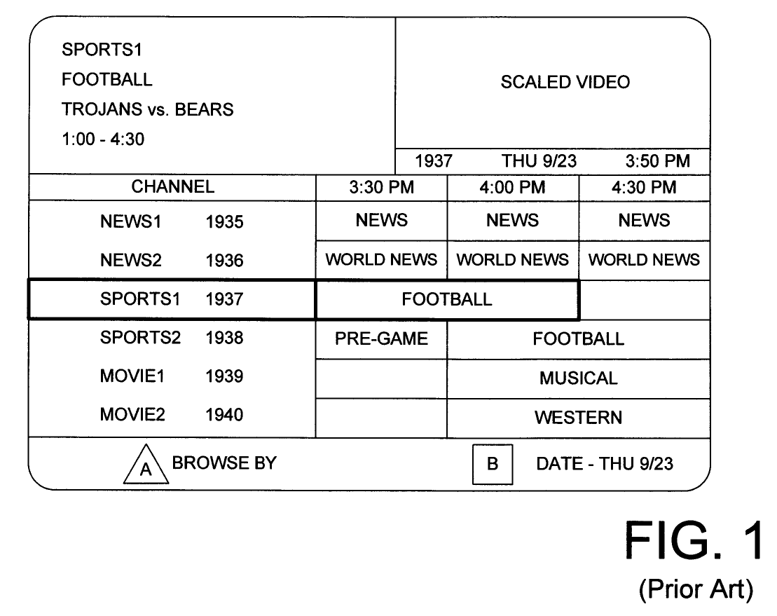

The television program titled “FOOTBALL1” which corresponds with SPORTS1 channel 1937 is identified by reference number 340. As in FIG. 1, the edges of the program instance field having the text for identifying the football television program 340 and the edges of the field having the text of the corresponding channel are both bolded to depict being highlighted as a result of user interaction such as scrolling through the program grid to select field 340. However, FIG. 3 is distinguishable from FIG. 1 because of the magnifying glass effect 310 depicted in FIG. 3 in association with selectable fields 310, 340. The magnifying glass effect corresponds to the highlighted or selectable fields.

In the embodiment of FIG. 3, the magnifying glass effect 310 is depicted by an oblong shape, or otherwise shaped different than the field, centered on at least a portion of one or more fields of the user interface screen 300 that completely encompasses the text of one or more fields, such as the title of a program and/or the channel name and number. Oblong is defined as a shape that is longer than it is wide, especially a rectangular or roughly elliptical shape, but other shapes may also be used. The user could choose whether only the channel name and number, only the program title, or both appear using the magnifying glass effect 310. As the user scrolls through the user interface screen 300, the channel and program information will scroll underneath the magnifying glass effect 310 and the text currently under the magnifying glass effect 310 will appear larger. For example in FIG. 3, the SPORTS1 channel 1937 and FOOTBALL are currently underneath the magnifying glass effect 310. This text appears with the magnifying glass effect 310 and is shown in the same font, but at a larger size. An algorithm is used to determine the amount of magnification or the user could choose a font size. The text could also appear in a different font chosen by the user.

The shape and size of the magnifying glass effect 310 may be varied. However, preferably at least a portion of the magnifying glass effect 310 corresponds with a highlighted or selectable field. The present invention is not limited to the particular shape or size of any magnifying glass effect specifically indicated in the present invention. If the magnifying glass effect 310 is always in use, the area underneath the magnifying glass effect 310 could be large enough to encompass more than one line of text across more than one channel. The magnifying glass effect 310 can also encompass one or more fields in a line of text of a channel. For example, a user could have both the channel name and number “SPORTS1 1937” as well as the program name “FOOTBALL” magnified. When scrolling to the left and when previous information can no longer be accessed, the magnifying glass effect 310 will only magnify the channel name and number “SPORTS1 1937”. When the magnifying glass effect 310 is magnifying only the channel name and number “SPORTS1 1937”, the remote control could be used to scroll and increase the magnifying glass effect 310 to cover both the channel name and number “SPORTS1 1937” and the program name “FOOTBALL” 340 as shown in FIG. 3.

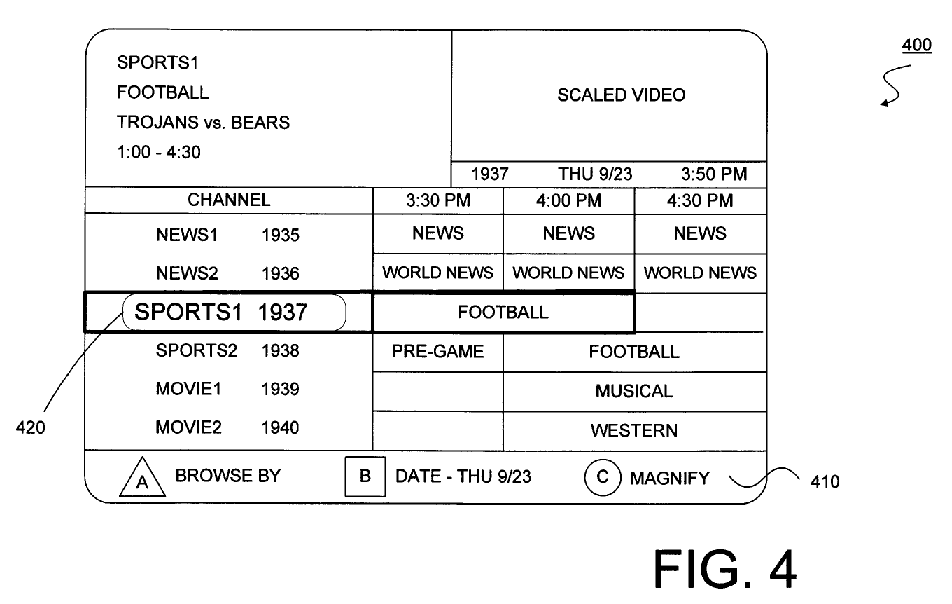

In the embodiment of FIG. 4, the IPG has a button activated magnifying glass. The user could choose to always have the magnifying glass effect in use or to only be activated when a button on the remote control is pressed, such as the “C” button. The magnifying glass effect could also be activated after a field has been highlighted for a specified period of time or if a button on the remote control is held down for a specified period of time the highlighted field will become magnified. FIG. 4 shows the “C” button 410 on the bottom of the user interface screen 400. The button is labeled “MAGNIFY” and when pressed, the channel and/or program in the middle of the user interface screen 400 would be displayed with the magnifying glass effect. For example, if a user has pressed the “C” button 410, the channel name “SPORTS1 1937” 420 appear magnified. The user could then move the magnifying glass effect around the user interface screen 400 using the arrow buttons on the remote control.

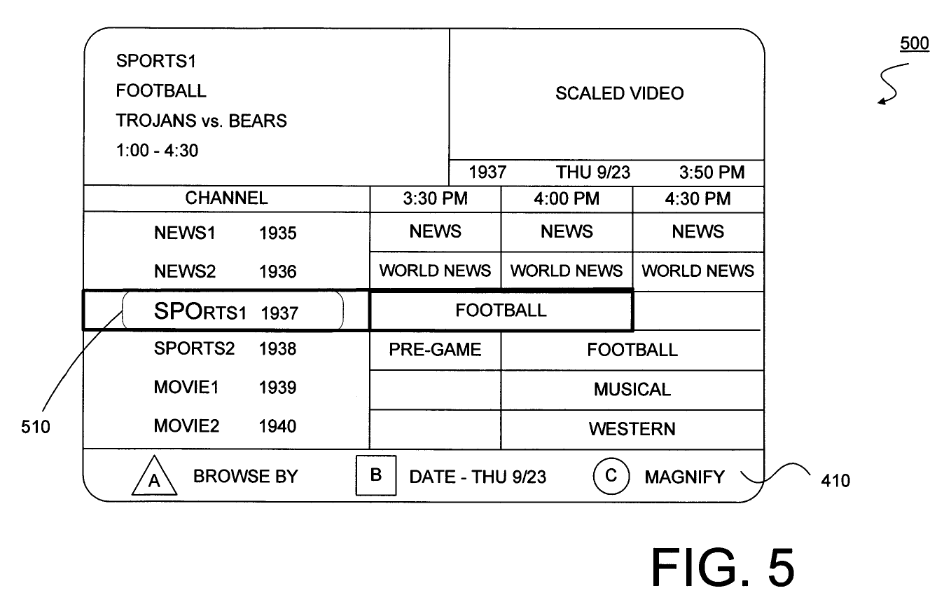

In the embodiment of FIG. 5, the IPG can have only a portion of the displayed text in a single field magnified. The user could choose to always have the magnifying glass effect in use or to only be activated by user input, such as when a button on the remote control is pressed. Once a field is highlighted, using a button on the remote control such as the select button, arrow buttons, or “C” button could cause the first letter of the displayed text to become magnified, or increase in font size. As the button is pressed a second time, the next letter will become magnified. FIG. 5 shows the channel name and number “SPORTS1 1937” 510 being partially magnified so that only the first three letters are magnified “SPORTS1 1937”. The “C” button 410 could also be used to then magnify the entire text of the field. For example, the button could be held down continuously for a period of time to magnify all the text in the field.

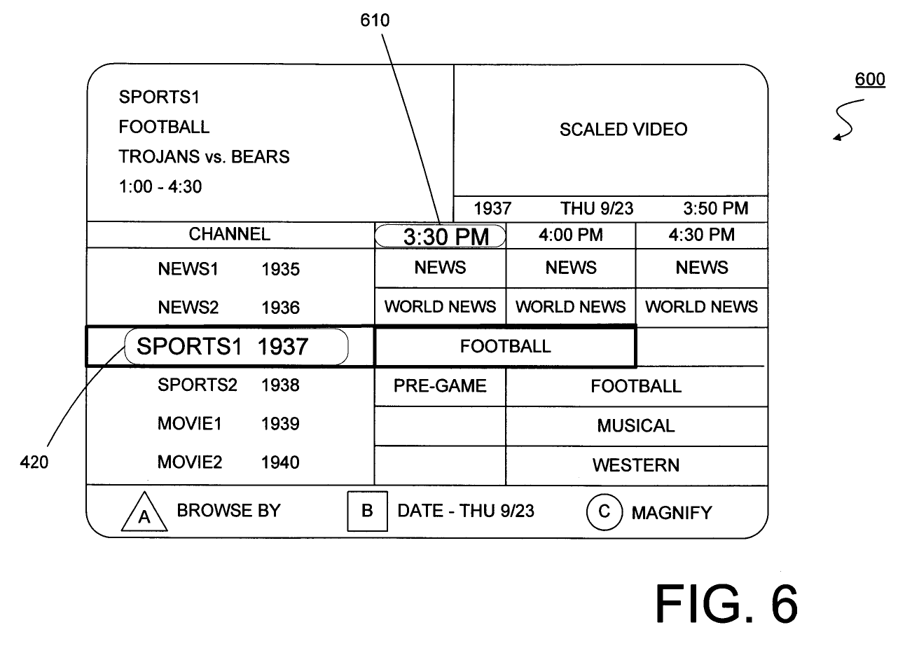

In the embodiment of FIG. 6, two instances of the magnifying glass effect are depicted on the user interface screen 600. The magnifying glass effect 310 is used to magnify the text “SPORTS1 1937”, as discussed in FIG. 3. The second instance of the magnifying glass effect 610 could be used on any field in the user interface screen 600 that the user specifies. For example, the second instance of the magnifying glass effect 610 is used to magnify the current time in a time field corresponding with a selectable program instance field. The magnifying glass effect 610 could also be button activated and moved around the user interface screen 600 using the arrow buttons on the remote control.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. An electronic program guide (EPG) comprising:
a user interface screen comprising one or more images arranged to provide a background in association with displayed text, at least a portion of said one or more images corresponding with a portion of said displayed text to define a field; and
a magnifying glass effect depicted in association with at least a portion of said field when one of said fields is selectable in response to user input, said magnifying glass effect defined by an increased font size corresponding with the text in the selectable field.

2. The EPG of claim 1, wherein said magnifying glass effect is substantially oblong in shape.

3. The EPG of claim 1, wherein said magnifying glass effect is a different shape from the selectable field.

4. The EPG of claim 1, wherein said user determines the size of said magnifying glass effect.

5. The EPG of claim 1, wherein a user determines the font size of said text underneath said magnifying glass effect.

6. The EPG of claim 1, wherein an algorithm determines the increased font size of said text underneath said magnifying glass effect.

7. The EPG of claim 1, wherein the magnifying glass effect is activated by subsequent response to an input device from a user.

8. The EPG of claim 1, wherein said magnifying glass effect is stationary and depicted in a fixed position relative to a grid of said screen, wherein text moving underneath said magnifying glass effect is displayed in a larger font than other text in said user interface screen.

9. The EPG of claim 1, wherein said magnifying glass effect is depicted in association with another field when activated by subsequent response to an input device.

10. The EPG of claim 1, wherein said field depicts current channel information;
another field depicts current program information; and
said magnifying glass effect is depicted in association with both fields.

11. An electronic program guide (EPG) comprising:
a user interface screen comprising one or more images arranged to provide a background in association with displayed text, at least a portion of said one or more images corresponding with a portion of said displayed text to define a field; and
a magnifying glass effect depicted in association with said field being highlighted for a specified period of time, said magnifying glass effect defined by an increased font size corresponding with the text in the selectable field.

12. The EPG of claim 11, wherein said magnifying glass effect is substantially oblong in shape.

13. The EPG of claim 11, wherein said magnifying glass effect is a different shape from the currently selectable field.

14. The EPG of claim 11, wherein a user determines the font size of said text underneath said magnifying glass effect.

15. The EPG of claim 11, wherein an algorithm determines the increased font size of said text moving underneath said magnifying glass effect.

16. The EPG of claim 11, wherein said user determines the size of said magnifying glass effect.

17. A method for increasing font size of text within a specified area of an electronic program guide (EPG), said method comprising the following steps:
said user navigating through a plurality of fields of a user interface screen;
identifying one of said fields as being selectable based upon said user's interaction with said EPG;
in subsequent response to an input device, rendering a magnifying glass effect in association with at least a portion of text in said selectable field; and
utilizing an increased font size in association with at least a portion of text in said selectable field in order to render said magnifying glass effect.

18. The method of claim 17, further comprising the step of rendering said magnifying glass effect in association with another field in response to subsequent response to an input device.

19. The method of claim 17, further comprising the step of removing said rendering of said magnifying glass effect in association with said another field in response to subsequent response to an input device.

20. The method of claim 17, further comprising the step of rendering said magnifying glass effect in association with another field, wherein said another field is current program information.

21. A method for increasing font size of text within a specified area of an electronic program guide (EPG), said method comprising the following steps:
said user navigating through a plurality of fields of a user interface screen;
identifying one of said fields as being selectable based upon said user's interaction with said EPG;
in response to one of said items being selectable, rendering a magnifying glass effect in association with at least a portion of text in said highlighted field; and
utilizing an increased font size in association with at least a portion of text in said selectable field in order to render said magnifying glass effect.

22. An electronic program guide (EPG) comprising:
a user interface screen comprising one or more images arranged to provide a background in association with displayed text, at least a portion of said one or more images corresponding with a portion of said displayed text to define a field;
a first magnifying glass effect depicted in association with at least a portion of a selectable program instance field, said magnifying glass effect defined by an increased font size corresponding with the text in the selectable field; and
a second magnifying glass effect depicted in association with at least a portion of a time field corresponding with a selectable program instance field, said magnifying glass effect define by an increased font size corresponding with the text in said field.

23. The EPG of claim 22, wherein first magnifying glass effect also encompasses field containing channel information.
